(19) United States
(12) Patent Application Publication
(10) Pub. No.: US 2011/0047565 A1
(43) Pub. Date: Feb. 24, 2011

(54) Data Transmitting and Receiving System

(75) Inventor: Takafumi NAKASE, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/786,941

(22) Filed: May 25, 2010

(30) Foreign Application Priority Data
May 25, 2009 (JP) 2009-125074

(51) Int. Cl. H04H 60/32

(52) U.S. Cl. 725/14

(57) ABSTRACT

Disclosed is a data transmitting and receiving system including: a data transmitting device; and a data receiving device connected to the data transmitting device through an HDMI, wherein the data transmitting device includes: an extracting section to extract contents information of a video; and a transmitting section to transmit contents information to the data receiving device, and the data receiving device includes: a receiving section to receive contents information; an acquiring section to acquire keyword and/or category information from the contents information; a storing section to store the keyword and/or category information; a determining section to compare the keyword and/or category information stored in the storing section with EPG data and to determine whether or not there is a match; and a display section to display with highlight program information of the EPG data determined by the determining section to match with the keyword and/or category information.

### BACKGROUND OF THE INVENTION

1. Field of the Invention

The present invention relates to a data transmitting and receiving system.

2. Description of Related Art

Lately, as television broadcast receivers become digitalized, the number of viewable channels has increased, and digital radio broadcast and data broadcast can also be received. Also, as the screen of the television becomes larger, method of connection between the television and external devices has increased in variation and linkage between the connected devices has become possible.

As a digital interface to transmit a video between AV (Audio Visual) devices, HDMI (High Definition Multimedia Interface) has become common. In HDMI, CEC (Consumer Electronics Control) line which can transmit and receive data bi-directionally is standardized.

Conventionally, a plurality of cables was used for each signal of video, audio and control in connection between devices. With HDMI, only one cable is used and the control signal can be transmitted bi-directionally. Therefore, for example, by relaying a control signal from a monitor to an output device such as a STB, DVD player, etc. connected by HDMI, the entire AV system such as a home theater can be operated by one remote controller.

As the number of channels increase, for settings of a television provided with such HDMI, there is a proposed technique where a keyword is registered by input from a user and when the EPG (Electric Program Guide) is displayed, the programs displayed on the EPG is searched using the registered keyword, and a list of the programs which matches the keyword is displayed (For example, Japanese Patent Application Laid-Open Publication No. 2003-319285).

However, since such registration of the keyword is performed by the user, there is a problem that the setting is troublesome.

### SUMMARY OF THE INVENTION

It is, therefore, a main object of the present invention to provide a data transmitting and receiving system between AV devices connected through the HDMI using the CEC line where information concerning a program of a user's preference can be notified to the user without performing registration and thus enhances usability.

According to an aspect of the present invention, there is provided a data transmitting and receiving system including:

a data transmitting device; and

a data receiving device connected to the data transmitting device through an HDMI (High Definition Multimedia Interface), wherein

the data transmitting device includes:
an extracting section to extract contents information of a video played on the data transmitting device; and
a transmitting section to transmit contents information extracted by the extracting section to the data receiving device through a CEC (Consumer Electronics Control) line of the HDMI, and

the data receiving device includes:
a receiving section to receive contents information transmitted by the transmitting section;
an acquiring section to acquire keyword and/or category information from the contents information received by the receiving section;
a storing section to store the keyword and/or category information acquired by the acquiring section;
a determining section to compare the keyword and/or category information stored in the storing section with EPG (Electronic Program Guide) data and to determine whether or not there is a match, when an EPG is displayed; and
a display section to display with highlight program information of the EPG data determined by the determining section to match with the keyword and/or category information, when the EPG is displayed.

According to another aspect of the present invention, there is provided a data transmitting and receiving system including:

a data transmitting device; and

a data receiving device connected to the data transmitting device through an HDMI, wherein

the data transmitting device includes:
an extracting section to extract contents information of a video played on the data transmitting device; and
a transmitting section to transmit contents information extracted by the extracting section to the data receiving device through a CEC line of the HDMI, and

the data receiving device includes:
a receiving section to receive contents information transmitted by the transmitting section wherein the receiving section can be connected to the Internet;
an acquiring section to acquire keyword and/or category information from the contents information received by the receiving section;
a searching section to search for keyword and/or category information using the contents information on the Internet connected to the data receiving device when the acquiring section cannot acquire keyword and/or category information from the contents information;
a storing section to store the keyword and/or category information acquired by the acquiring section and to store the keyword and/or category information searched by the searching section when the acquiring section cannot acquire keyword and/or category information from the contents information;
a determining section to compare the keyword and/or category information stored in the storing section with EPG data and to determine whether or not there is a match, when an EPG is displayed and when the data receiving device is started;
a display section to display with highlight program information of the EPG data determined by the determining section to match with the keyword and/or category information, when the EPG is displayed; and
a notifying section to notify to a user program information of the EPG data determined to match with the keyword and/or category information by the determining section with a popup display when the data receiving device is started.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, and wherein:

FIG. 1 is an overall block diagram of a configuration of a data transmitting and receiving system of the present embodiment;

FIG. 2 is a block diagram showing a control configuration of a playback device and a display device in a data transmitting and receiving system of the present embodiment;

FIG. 3 is a diagram showing an example of an EPG displayed on a display section when a display program is executed;

FIG. 4 is a diagram showing an example of when a popup cell is displayed on the display section when a notifying program is executed;

FIG. 5 is a flow chart showing a display processing (highlighted display, popup display) performed in the data transmitting and receiving system of the present embodiment; and

FIG. 6 is a flow chart showing an acquisition processing which is a processing of the display processing.

### DESCRIPTION OF THE PREFERRED EMBODIMENTS

The best mode for carrying out the present invention will be explained in detail with reference to the drawings. However, the scope of the invention is not limited to the illustrated examples.

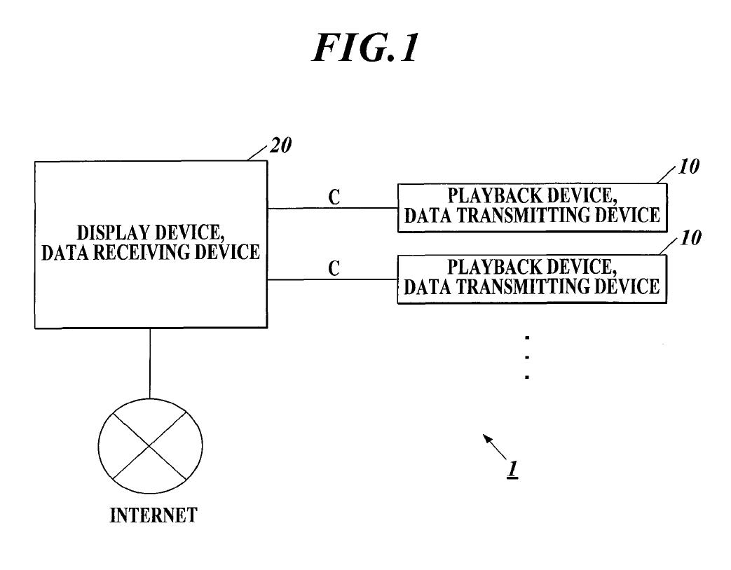

FIG. 1 is a diagram showing a configuration of the data transmitting and receiving system 1 of the present embodiment.

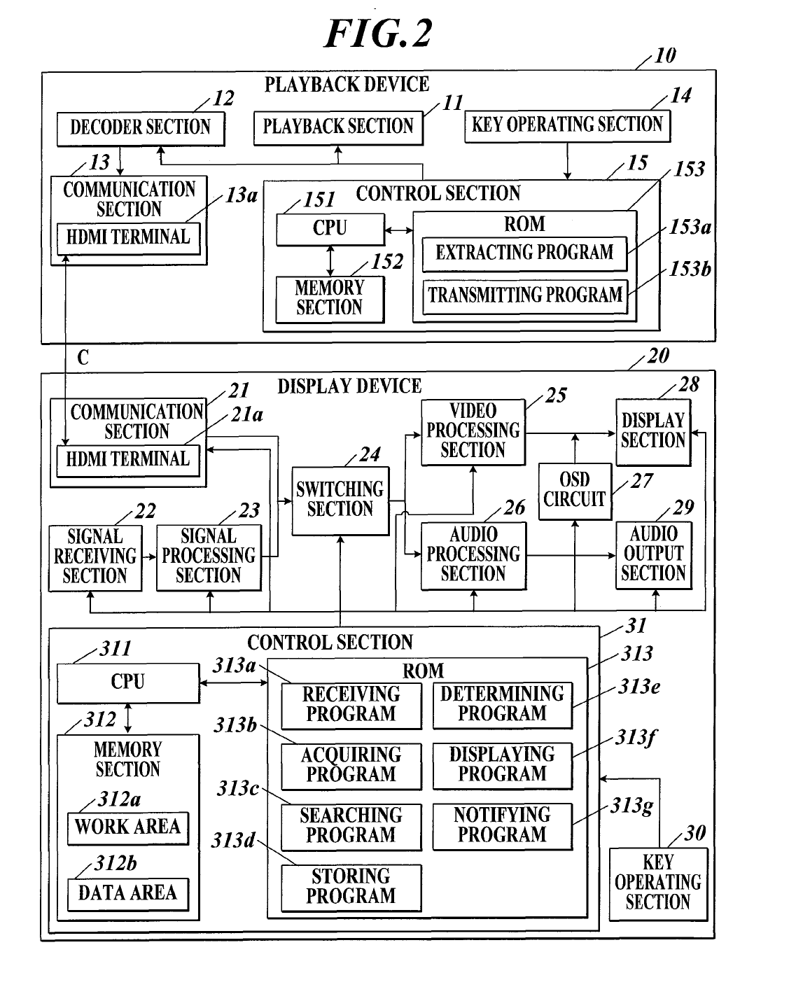

As shown in FIG. 1 and FIG. 2, the data sending and receiving system 1 includes a playback device (data transmitting device) 10 and a display device (data receiving device) 20.

The playback device 10 and the display device 20 are connected to each other by an HDMI cable C of an HDMI (High Definition Multimedia Interface) standard and video data and audio data are transmitted with a control signal from the playback device 10 to the display device 20 through the HDMI.

The HDMI cable C is divided between a CEC line to pass a CEC signal and a video/audio line to pass a video/audio signal. The CEC line is configured so as to be able to transmit and receive the CEC signal to each other between a control section 15 and a control section 31 (see FIG. 2) of the playback device 10 and the display device 20. The video/audio line transmits and receives the video/audio signal through a communication section 13 and a communication section 21 (see FIG. 2) provided in each device. This is so that there is no unscrambled video signal or audio signal on the HDMI cable from the viewpoint of copyright protection.

FIG. 2 is a block diagram showing a control configuration of the playback device 10 and the display device 20.

First, the configuration of the playback device 10 is described.

The playback device 10 is a DVD player to play video data, etc. recorded on, for example, a DVD (Digital Versatile Disc).

As shown in FIG. 2, the playback device 10 is connected to the display device 20, which displays video based on video data to be played on the playback device 10, through the HDMI cable C and the playback device 10 transmits video data to be played and contents information of the played video through the HDMI cable C to the display device 20.

For example, the playback device 10 includes a playback section 11 to read out image data recorded on a DVD which is not shown, a decoder section 12 to perform predetermined decoding processing on the video data read out in the playback section 11, a communication section 13 to transmit video data output from the decoder section 12 to an external device such as the display device 20, etc., a key operating section 14 for the user to input various instructions, a control section 15 to centrally control each section of the playback device 10, and the like.

For example, the playback section 11 exposes laser light to a reflecting layer of the DVD and generates a voltage signal according to the reflected light by photoelectric conversion and current voltage conversion to read out the video data, etc. recorded on the DVD to output the read out video data, etc. to the decoder section 12.

For example, although not shown, the decoder section 12 includes a separating section, video decoder, audio decoder, and the like. In the separating section, the contents data input from the playback section 11 is separated into a plurality of pieces of data such as video data, audio data, sub-video data, etc., to output the separated video data to the video decoder and the separated audio data to the audio decoder. Then, in the video decoder, the separated video data is decoded according to MPEG format and in the audio decoder, the separated audio data is decoded according to MPEG audio format.

The communication section 13 includes a group of video input/output terminals corresponding to various interfaces and the video data input from the decoder section 12 and the contents information are transmitted through the video input/output terminals to the display device 20.

Specifically, the communication section 13 includes an HDMI terminal 13a corresponding to the HDMI and through the HDMI terminal 13a, video data, audio data, etc. input from the decoder section 12 is transmitted with the control signal to the display device 20.

The communication section 13 transmits contents information input from the decoder section 12 through the CEC line of the HDMI cable C to the display device 20. In other words, with a later described transmitting program 153b, the communication section 13 functions as a part of a transmitting section.

For example, the key operating section 14 includes a plurality of keys for the user to input various instructions and when a user presses a key, an input operation signal corresponding to the pressed key is output to the control section 15.

The control section 15 includes a CPU (Central Processing Unit) 151, memory section 152, ROM (Read Only Memory) 153, and the like.

The CPU 151 executes various programs stored in the ROM 153 according to an input signal input from each section of the playback device 10, input operation signal based on operation of pressing various keys on the key operating section 14, etc., and outputs an output signal to each section of the playback device 10 based on the executed programs and centrally controls general operation of the playback device 10.

For example, the memory section 152 includes a work area composed from a volatile memory such as a RAM (Random Access Memory) and the processing result generated when various programs are executed by the CPU 151, input data, etc. are stored in the work area.

For example, the ROM 153 includes a program storage area composed from a nonvolatile memory and stores an extracting program 153a, a transmitting program 153b, etc.

For example, the extracting program 153a is a program to allow the CPU 151 to realize a function of extracting contents information of a video played on the playback device 10.

Specifically, for example, when a video is played on the playback device 10, the CPU 151 executes the extracting program 153a to extract contents information from the video data of the video.

The “video data” includes various text data and various information such as still image data, moving image data, music data, audio data, etc. stored in a storage medium such as a DVD.

Also, “contents information” includes various information concerning contents such as category information, title information, cast information, recording date information, etc. included in the text data of the “video data”.

The category information shows the category of the video and for example, is categorized such as movie/drama, sports, movie, entertainment, news, etc.

The title information shows the title of the video, and for example, in a DVD of a movie, the title of the story is the title information and in a DVD of music, the title of the song is the title information.

The cast information shows the name of the people who appear in the video and the recording data information shows the date the video was recorded in the medium.

The CPU 151 executes the extracting program 153a to function as an extracting section.

For example, the transmitting program 153b is a program to allow the CPU 151 to realize a function of transmitting contents information, which is extracted by executing the extracting program 153a, through the CEC line of the HDMI to the display device 20.

Specifically, when the CPU 151 extracts contents information by executing the extracting program 153a, the CPU 151 outputs the contents information to the communication section 13 and transmits the contents information from the HDMI terminal 13a of the communication section 13 through the HDMI cable C to the display device 20.

An arrangement concerning the data transmitting and receiving by the CEC line between the devices is determined between the transmitting program 153b of the playback device 10 and a receiving program 313a (later described) of the display device 20 and this enables data to be transmitted and received by the CEC line between the playback device 10 and the display device 20.

The CPU 151 executes the transmitting program 153b to function as a transmitting section with the communication section 13.

Next, the configuration of the display device 20 is described.

For example, the display device 20 is a television receiver which displays video based on video data, etc. input from a television broadcasting station or an external device such as the playback device 10, etc.

As shown in FIG. 2, the display device 20 is connected to the playback device 10 to input various data such as video data by an HDMI cable C. The display device 20 displays the video based on the video data input from the playback device 10 through the HDMI cable C.

The display device 20 includes a communication section 21 to receive video data, etc. transmitted from the external device such as the playback device 10, etc., a signal receiving section 22 to receive broadcast signals, a signal processing section 23 to perform predetermined signal processing such as demodulating, decoding, etc. on the video data, etc., a switching section 24 to select switching of input data, a video processing section 25 to perform predetermined video processing on the video data, an audio processing section 26 to perform predetermined audio processing on audio data, an OSD circuit 27 to add OSD (On Screen Display) data on video data input to a display section 28, the display section 28 to display video based on video data input from the video processing section 25, an audio output section 29 to output audio based on audio data input from the audio processing section 26, a key operating section 30 for a user to input various instructions, a control section 31 to centrally control each section of the display device 20, and the like.

The communication section 21 includes a video input and output terminal group corresponding to various interfaces and receives video data transmitted from the communication section 13 of the playback device 10 through the video input and output terminal.

Specifically, the communication section 21 includes an HDMI terminal 21a corresponding to the HDMI and the communication section 21 receives video data transmitted with the audio data and control signal from the playback device 10 through the HDMI terminal 21a.

The signal receiving section 22 includes an antenna, a tuner, etc. and receives broadcast signals sent from the television broadcasting station.

The signal processing section 23 performs predetermined signal processing such as demodulating, decoding, etc. on the video data, etc. input from the signal receiving section 22.

According to control by the control section 31, the switching section 24 switches between the HDMI terminal 21a provided in the communication section 21 and the signal processing section 23 to select switching of input data to output to the later processing sections of video processing section 25, audio processing section 26, etc.

The video processing section 25 performs various video processing on the video data input from the switching section 24 and generates a video signal to output the generated video signal to the display section 28.

The audio processing section 26 performs various audio processing on the audio data input from the switching section 24 and generates an audio signal to output the generated audio signals to the audio output section 29.

The OSD circuit 27 performs processing to combine OSD data not shown stored in the memory section 312, etc. on the video data output to the display section 28.

For example, the display section 28 includes a display not shown such as an LCD (Liquid Crystal Display), etc., and displays video based on video data input from the video processing section 25 and EPG (Electronic Program Guide) on the display.

The display section 28 functions as a display section with a later described displaying program 313f.

The audio output section 29 includes a speaker, etc. not shown and outputs audio based on audio data input from the audio processing section 26 from the speaker.

The control section 31 includes a CPU 311, a memory section 312, a ROM 313, etc.

The CPU 311 executes various programs stored in the ROM 313 according to an input signal input from each section of the display device 20, input operation signal based on operation of pressing various keys on the key operating section 30, etc., and outputs an output signal to each section of the display device 20 based on the executed programs to centrally control general operation of the display device 20.

For example, the memory section 312 includes a work area 312a including the volatile memory such as the RAM, etc., and the processing result generated when various programs are executed by the CPU 311, input data, etc. are stored in the work area 312a. Also, the memory section 312 includes a data area 312b including a nonvolatile memory such as an EPROM (Erasable Programmable ROM), etc.

The memory section 312 functions as a storage section with a later described storing program 313d.

For example, the ROM 313 includes a program storage area composed of the nonvolatile memory. Specifically, the ROM 313 stores the receiving program 313a, an acquiring program 313b, a searching program 313c, the storing program 313d, a determining program 313e, the displaying program 313f, a notifying program 313g and the like.

For example, the receiving program 313a is a program to allow the CPU 311 to realize the function of receiving contents information transmitted through the HDMI by executing the transmitting program 153b in the playback device 10.

Specifically, when contents information is sent through the HDMI cable C from the playback device 10 connected to the display device 20, the CPU 311 receives the contents information through the HDMI terminal 21a of the communication section 21.

The CPU 311 executes the receiving program 313a to function as a receiving section with the communication section 21.

For example, the acquiring program 313b is a program to enable the CPU 311 to realize the function of acquiring keyword and/or category information from the content information received by performing the receiving program 313a.

Specifically, the CPU 311 executes the acquiring program 313b to select the keyword and/or category information set in advance from the various information included in the contents information and obtains the keyword and/or category information.

For example, the name of the main cast of the video recorded on the recording medium such as the DVD can be used as the keyword.

The data used as the keyword among the data in the contents information is determined in advance as the factory default and is stored in the memory section 312.

The CPU 311 executes the acquiring program 313b to function as the acquiring section.

For example, the searching program 313c is a program to allow the CPU 311 to realize the function of searching the keyword and/or category information using the contents information on the Internet connected to the playback device 10 when the keyword and/or category information cannot be acquired from the contents information by executing the acquiring program 313b.

Specifically, for example, in a case where a DVD is used as the recording medium, when the keyword and/or category information is not included in the contents information, the CPU 311 executes the searching program 313c and searches and obtains the keyword and/or category information of the contents by the merchandise number (identification number unique to the work), etc., included in the contents information in a specific Web site (for example, music store) on the Internet.

The CPU 311 executes the searching program 313c to function as a searching section.

For example, the storing program 313d is a program to allow the CPU 311 to realize the function of storing the keyword and/or category information acquired by executing the acquiring program 313b and the searching program 313c.

Specifically, the CPU 311 executes the storing program 313d to store the keyword and/or category information acquired in the data area 312b of the memory section 312.

The keyword and category information stored in the memory section 312 is accumulated as required each time the recording medium such as the DVD is played in the playback device 10. Each time the same keyword or category information is accumulated, “+1” is incremented and the frequency of use is counted.

The CPU 311 executes the storing program 313d to function as a storing section with the memory section 312.

For example, the determining program 313e is a program to allow the CPU 311 to realize the function of comparing the keyword and/or category information stored in the memory section 312 by executing the storing program 313d to the EPG data when the EPG is displayed, and determining whether or not there is a match.

Specifically, when the EPG is displayed, the CPU 311 executes the determining program 313e to compare each one of the keyword or category information stored in the memory section 312 to the EPG data for each program and determines whether or not there is a match of keyword or category information in the EPG data.

The CPU 311 executes the determining program 313e to function as a determining section.

For example, the displaying program 313f is a program to allow the CPU 311 to realize the function of highlight display of program information of EPG data determined to match the keyword and/or category information by performing the determining program 313e when the EPG is displayed.

Specifically, when the CPU 311 determines there is keyword or category information in the EPG data which matches the keyword or category information stored in the memory section 312 by executing the display program 313f, the CPU 311 performs highlighted display of the program information (program cell) including the keyword or category information. Highlighted display is to display so as to be able to distinguish between the corresponding program information and the other program information at a glance, for example, making the border of the corresponding program information bold, coloring inside the border, making the letters bold, etc.

The display format of program information including both the keyword and the category information and the program information including only either one of the keyword or category information can be different.

For example, the display format can be set so program information including both can have a bold border and be colored inside the border, and program information including only either one can have only a bold border. Consequently, the user can easily understand the priority rank of the program.

The CPU 311 executes the display program 313f to function as a display section with the display section 28.

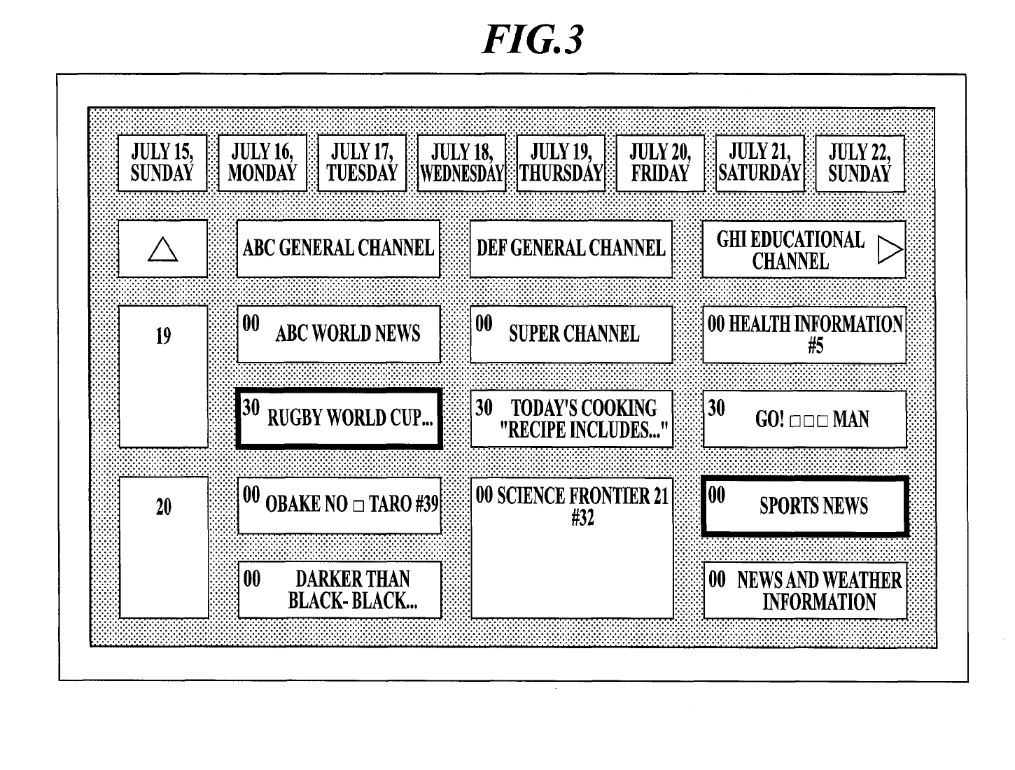

FIG. 3 is a figure showing an example of an EPG displayed on the display section 28 by executing the display program 313f. The EPG shown in FIG. 3 is composed of a date display area, a channel display area, a broadcast time frame display area and a program information display area. In the program information display area, the program cell displaying the program information concerning each broadcast program is arranged in channel order in the horizontal direction and in the broadcast time order in the vertical direction.

Each program cell has a length in the vertical direction according to the length of the broadcast time of the corresponding broadcast program and the broadcast starting time and the title information is drawn in each program cell.

In the EPG shown in FIG. 3, as for a broadcast program where the whole title information can be stored in the program cell, the whole title information is displayed in the program cell such as in “ABC WORLD NEWS”, etc. and as for a broadcast program where the whole title information cannot be stored in the program cell, only the beginning portion of the title information is displayed in the program cell such as in “RUGBY WORLD CUP . . . ”. The program cell in the EPG including the information which matches the keyword and/or the category information has a bold border.

FIG. 3 shows an example where “sports” is included in the category information, and thus “RUGBY WORLD CUP . . . ” and “SPORTS NEWS” has a bold border.

For example, the notifying program 313g is a program to allow the CPU 311 to realize a function to notify the user of program information in the EPG data determined to match with the keyword and/or category information by executing the determining program 313e with a popup display when the display device 20 is started.

Specifically, the CPU 311 executes the notifying program 313g and when there is program information including information to match with the keyword and/or category information in a program currently broadcast at the time the display device 20 is started, the corresponding program information is displayed in the display of the display section 28 as popup cell P.

The CPU 311 executes the notifying program 313g to function as a notifying section.

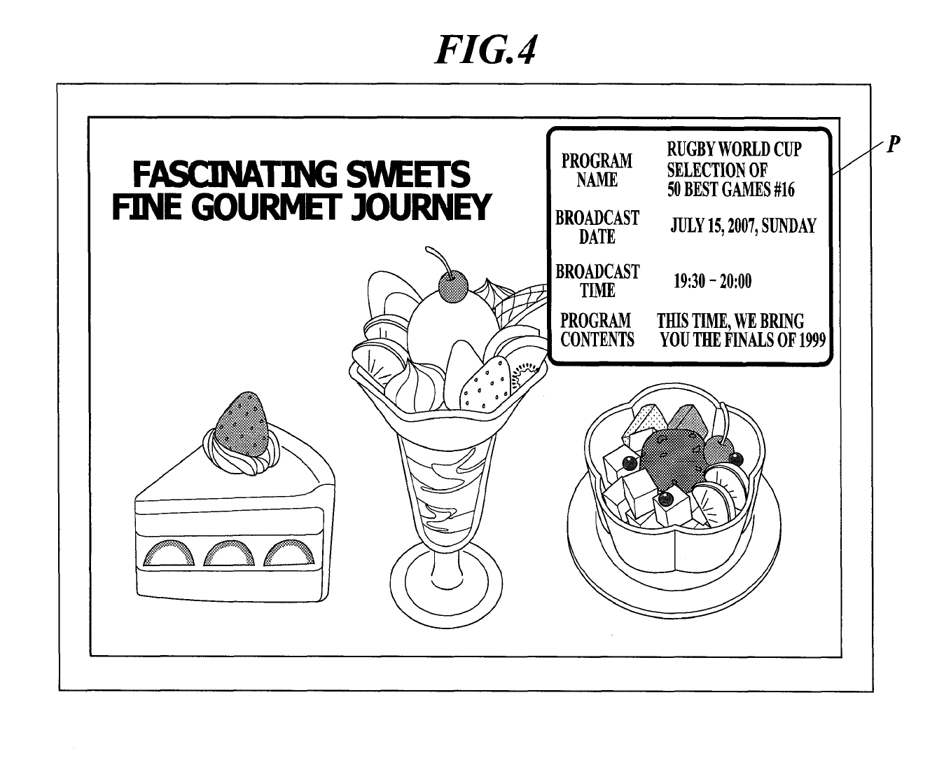

FIG. 4 is a diagram showing an example of a popup cell P displayed on the display section 28 by executing the notifying program 313g. Detailed information of the program (for example, program name, broadcast date, broadcast time, content of program, etc.) is drawn inside the popup cell P shown in FIG. 4. Alternatively, for example, other information concerning the broadcast program such as cast, category and the like can be displayed in the popup cell P.

Next, the operation of the data transmitting and receiving system 1 of the present embodiment is described.

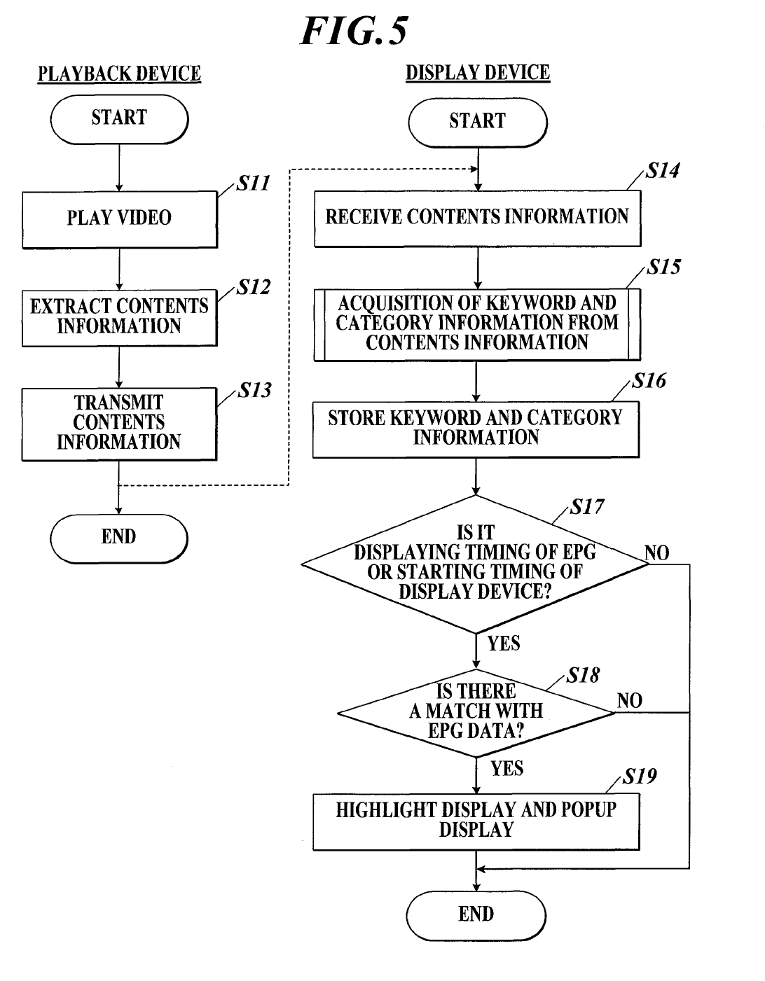

FIG. 5 is a flowchart showing a display processing (highlight display, popup display) performed by the data transmitting and receiving system 1 of the present embodiment.

In the processing described below, steps S11 to S13 are performed by the playback device 10 and steps S14 to S19 are performed by the display device 20.

When the display processing starts, first, in step S11, the control section 15 of the playback device 10 plays the video.

Next, in step S12, the control section 15 extracts the contents information from the video data of the played video.

Next, in step S13, the control section 15 transmits the extracted contents information with the communication section 13 to the display device 20.

Next, in step S14, the control section 31 of the display device 20 receives on the communication section 21 the contents information transmitted from the playback device 10.

Next, in step S15, the control section 31 acquires the keyword and/or category information from the contents information.

Next, in step S16, the control section 31 stores the acquired keyword and/or category information in the data area 312b of the memory section 312.

Next, in step S17, the control section 31 determines whether or not it is the timing of displaying the EPG or it is the timing of starting the display device 20, and when it is not the timing of such displaying or starting, the processing ends.

When it is the timing of displaying the EPG or it is the timing of starting the display device 20 (step S17; YES), in the next step S18, the control section 31 compares the obtained keyword and/or category information with the data of the EPG and determines whether or not there is a match.

Then, when the obtained keyword and/or category information do not match with the data of the EPG (step S18; NO), the processing ends.

When it is determined there is a match (step S18; YES), in the next step S19, the control section 31 displays the highlight display or popup display on the display section 28 and ends the processing.

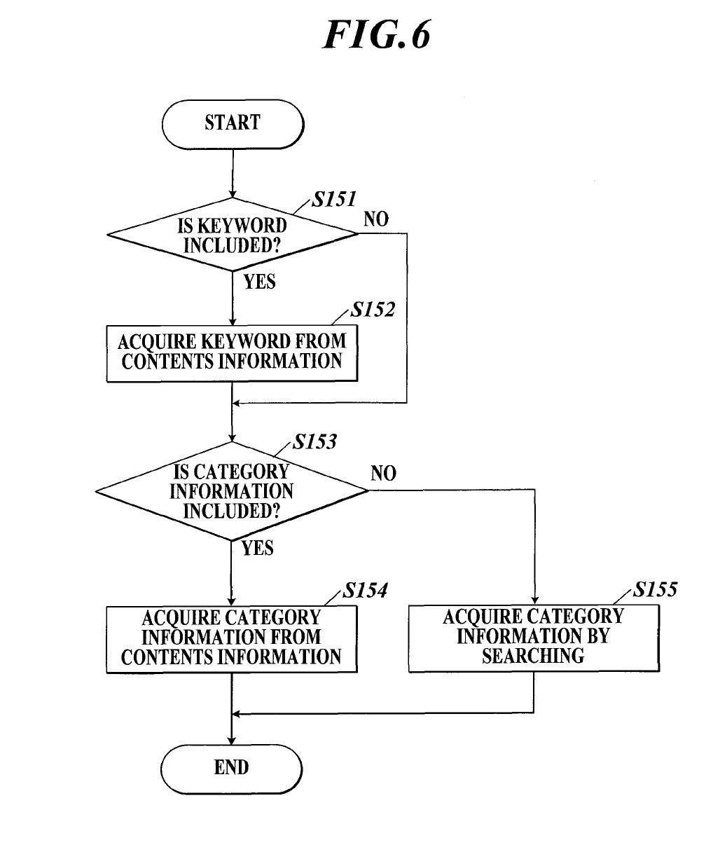

FIG. 6 is a flowchart showing the acquiring processing of the keyword and category information performed by the playback apparatus 10.

When the acquiring processing of the keyword and category information is started, first in step S151, the control section 31 determines whether or not the keyword is included in the contents information and when it is determined that the keyword is not included (step S151; NO), the processing advances to later described step S153.

When it is determined that the keyword is included (step S151; YES), in the next step S152, the control section 31 acquires the keyword from the contents information.

Next, in step S153, the control section 31 determines whether or not the category information is included in the contents information.

Then, when it is determined that the category information is included (step S153; YES), in the next step S154, the control section 31 acquires the category information from the contents information and ends the processing.

When it is determined that the category information is not included (step S153; NO), in the next step S155, the control section 31 searches and acquires the keyword and/or category information from the contents information using the Internet, and then ends the processing.

As described above, according to the data transmitting and receiving system 1 of the present embodiment, the display device 20 acquires the contents information of the played video from the playback device 10 connected by the HDMI and when the EPG is displayed on the display device 20, the program information is displayed with highlight based on the acquired contents information. Also, the program information is displayed with a popup display based on the acquired contents information when the display device 20 is started.

Therefore, a user is able to obtain information of a program of the user's preference without registration in advance, and thus improves usability.

The present embodiment is not limited to the above described examples and various modifications and change in design may be performed within the scope of the invention.

For example, in the highlighted display or popup display, different color arrangement can be used for each category. With this, the user can easily identify the program information of the user's preference.

Also, in the above described embodiment, when it is determined that the keyword and/or category information match, it is described that the display is highlighted or a popup display is used. Alternatively, for example, a keyword or category information with a frequency of use (count number) of a predetermined threshold or more can be compared preferentially and displayed highlighted or with a popup display and a keyword or category information which is smaller than the predetermined threshold does not have to be compared.

When the predetermined threshold is set, the user's preference can be reflected more easily.

According to an aspect of the preferred embodiments, there is provided a data transmitting and receiving system including:

a data transmitting device; and

a data receiving device connected to the data transmitting device through an HDMI (High Definition Multimedia Interface), wherein

the data transmitting device includes:
an extracting section to extract contents information of a video played on the data transmitting device; and
a transmitting section to transmit contents information extracted by the extracting section to the data receiving device through a CEC (Consumer Electronics Control) line of the HDMI, and

the data receiving device includes:
a receiving section to receive contents information transmitted by the transmitting section;
an acquiring section to acquire keyword and/or category information from the contents information received by the receiving section;
a storing section to store the keyword and/or category information acquired by the acquiring section;
a determining section to compare the keyword and/or category information stored in the storing section with EPG (Electronic Program Guide) data and to determine whether or not there is a match, when an EPG is displayed; and
a display section to display with highlight program information of the EPG data determined by the determining section to match with the keyword and/or category information, when the EPG is displayed.

Preferably, in the data transmitting and receiving system,

the data receiving device can be connected to the Internet;

the data receiving device further includes a searching section to search for keyword and/or category information using the contents information on the Internet connected to the data receiving device when the acquiring section cannot acquire keyword and/or category information from the contents information; and

the storing section stores the keyword and/or category information searched by the searching section when the acquiring section cannot acquire keyword and/or category information from the contents information.

Preferably, in the data transmitting and receiving system,

the determining section compares the keyword and/or category information stored in the storing section with the EPG data and determines whether or not there is a match when the data receiving device is started; and

the data receiving device includes a notifying section to notify to a user program information of the EPG data determined to match with the keyword and/or category information by the determining section with a popup display when the data receiving device is started.

According to another aspect of the preferred embodiments, there is provided a data transmitting and receiving system including:

a data transmitting device; and

a data receiving device connected to the data transmitting device through an HDMI, wherein

the data transmitting device includes:
an extracting section to extract contents information of a video played on the data transmitting device; and
a transmitting section to transmit contents information extracted by the extracting section to the data receiving device through a CEC line of the HDMI, and

the data receiving device includes:
a receiving section to receive contents information transmitted by the transmitting section wherein the receiving section can be connected to the Internet;
an acquiring section to acquire keyword and/or category information from the contents information received by the receiving section;
a searching section to search for keyword and/or category information using the contents information on the Internet connected to the data receiving device when the acquiring section cannot acquire keyword and/or category information from the contents information;
a storing section to store the keyword and/or category information acquired by the acquiring section and to store the keyword and/or category information searched by the searching section when the acquiring section cannot acquire keyword and/or category information from the contents information;
a determining section to compare the keyword and/or category information stored in the storing section with EPG data and to determine whether or not there is a match, when an EPG is displayed and when the data receiving device is started;
a display section to display with highlight program information of the EPG data determined by the determining section to match with the keyword and/or category information, when the EPG is displayed; and
a notifying section to notify to a user program information of the EPG data determined to match with the keyword and/or category information by the determining section with a popup display when the data receiving device is started.

According to the above aspects, the data receiving device acquires contents information of the played video from the data transmitting device connected to the HDMI, and when the EPG is displayed on the data receiving device, the program information is displayed with highlight based on the acquired contents information.

Therefore, a user is able to obtain information of a program of a user's preference without registration in advance and thus improves usability.

The entire disclosure of Japanese Patent Application No. 2009-125074 filed on May 25, 2009 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A data transmitting and receiving system comprising:
a data transmitting device; and
a data receiving device connected to the data transmitting device through an HDMI (High Definition Multimedia Interface), wherein
the data transmitting device includes:
an extracting section to extract contents information of a video played on the data transmitting device; and
a transmitting section to transmit contents information extracted by the extracting section to the data receiving device through a CEC (Consumer Electronics Control) line of the HDMI, and
the data receiving device includes:
a receiving section to receive contents information transmitted by the transmitting section;
an acquiring section to acquire keyword and/or category information from the contents information received by the receiving section;
a storing section to store the keyword and/or category information acquired by the acquiring section;
a determining section to compare the keyword and/or category information stored in the storing section with EPG (Electronic Program Guide) data and to determine whether or not there is a match, when an EPG is displayed; and
a display section to display with highlight program information of the EPG data determined by the determining section to match with the keyword and/or category information, when the EPG is displayed.

2. The data transmitting and receiving system according to claim 1, wherein,
the data receiving device can be connected to the Internet;
the data receiving device further includes a searching section to search for keyword and/or category information using the contents information on the Internet connected to the data receiving device when the acquiring section cannot acquire keyword and/or category information from the contents information; and
the storing section stores the keyword and/or category information searched by the searching section when the acquiring section cannot acquire keyword and/or category information from the contents information.

3. The data transmitting and receiving system according to claim 1, wherein
the determining section compares the keyword and/or category information stored in the storing section with the EPG data and determines whether or not there is a match when the data receiving device is started; and
the data receiving device includes a notifying section to notify to a user program information of the EPG data determined to match with the keyword and/or category information by the determining section with a popup display when the data receiving device is started.

4. A data transmitting and receiving system comprising:
a data transmitting device; and
a data receiving device connected to the data transmitting device through an HDMI, wherein
the data transmitting device includes:
an extracting section to extract contents information of a video played on the data transmitting device; and
a transmitting section to transmit contents information extracted by the extracting section to the data receiving device through a CEC line of the HDMI, and
the data receiving device includes:
a receiving section to receive contents information transmitted by the transmitting section wherein the receiving section can be connected to the Internet;
an acquiring section to acquire keyword and/or category information from the contents information received by the receiving section;
a searching section to search for keyword and/or category information using the contents information on the Internet connected to the data receiving device when the acquiring section cannot acquire keyword and/or category information from the contents information;
a storing section to store the keyword and/or category information acquired by the acquiring section and to store the keyword and/or category information searched by the searching section when the acquiring section cannot acquire keyword and/or category information from the contents information;
a determining section to compare the keyword and/or category information stored in the storing section with EPG data and to determine whether or not there is a match, when an EPG is displayed and when the data receiving device is started;
a display section to display with highlight program information of the EPG data determined by the determining section to match with the keyword and/or category information, when the EPG is displayed; and
a notifying section to notify to a user program information of the EPG data determined to match with the keyword and/or category information by the determining section with a popup display when the data receiving device is started.
